(19) United States
(12) Patent Application Publication
(10) Pub. No.: US 2016/0121508 A1
(43) Pub. Date: May 5, 2016

(54) A CUTTING DEVICE

(71) Applicants: Emanuell LEVITIN, Lehavim (IL); Ofer EDEN, Eilat (IL)

(72) Inventors: EMANUELL LEVITIN, LEHAVIM (IL); OFER EDEN, EILAT (IL)

(21) Appl. No.: 14/898,482

(22) PCT Filed: May 29, 2014
(86) PCT No.: PCT/IL2014/050483

§ 371 Date: Dec. 15, 2015

(30) Foreign Application Priority Data
Jun. 17, 2013 (IL) 226994

(51) Int. Cl. B26F 1/38; B26F 1/24; B26D 7/00; B26D 1/28; B26D 5/10

(52) U.S. Cl. CPC B26F 1/3846; B26D 1/285; B26D 5/10; B26D 7/0006; B26F 1/24

(57) ABSTRACT

A cutting device, comprising: a disc (16), for attaching a sheet (44), for stretching thereof while being cut; a rod (26), perpendicularly connected to a center of said disc (16), said rod (26) having a sharpened tip (12) at an end thereof for being anchored to said sheet (44), and for determining a 16 center of the stretched area of said sheet (44); a cutting tool (20) connected to said rod (26), said cutting tool employing a cutting terminal (18) disposed distantly from said rod (26); and a mechanism for rotating said cutting terminal circularly around said rod (26); wherein a length of said rod (26) allows holding said cutting device from a distance to said sheet; thereby stretching said sheet (44) for cutting a circular cut in said sheet (44) distantly from a user thereof.

### TECHNICAL FIELD

The present invention relates to the field of cutting devices. More particularly, the invention relates to a device for cutting holes in the plastic sheets of greenhouses.

### BACKGROUND ART

A greenhouse is a structure in which plants are grown. These structures range in size from small sheds to industrial-sized buildings.

A greenhouse is a structure with different types of covering materials, such as a glass or plastic roof and frequently, glass or plastic walls; it heats up because incoming visible solar radiation (for which the glass or plastic is transparent) from the sun is absorbed by plants, soil or other objects inside the structure. Air warmed by the heat from hot interior surfaces is retained in the structure by the roof and walls. In addition, the warmed objects and plants inside the greenhouse re-radiate some of their thermal energy in the infrared spectrum, to which glass and transparent plastic is partly opaque, so some of this energy is also trapped inside the greenhouse. However, this latter process is a minor player compared with the former (convective) process. Thus, the primary heating mechanism of a greenhouse is convection. This can be demonstrated by opening a small window near the roof of a greenhouse: the temperature drops considerably. This principle is the basis of the autovent automatic cooling system. Thus, the glass or plastic used for a greenhouse works as a barrier to air flow, and its effect is to trap energy within the greenhouse. The air that is warmed near the ground is prevented from rising indefinitely and flowing away.

Although heat loss due to thermal conduction through the glass or plastic occurs, net energy (and therefore temperature) increases inside the greenhouse.

Greenhouses can be divided into glass greenhouses and plastic greenhouses. Plastics mostly used are polyethylene film and multiwall sheets of polycarbonate material, or PMMA acrylic glass.

Greenhouses allow for greater control over the growing environment of plants. Depending upon the technical specification of a greenhouse, key factors which may be controlled include temperature, levels of light and shade, irrigation, fertilizer application, and atmospheric humidity. Greenhouses may be used to overcome shortcomings in the growing qualities of a piece of land, such as a short growing season or poor light levels, and they can thereby improve food production in marginal environments.

As they may enable certain crops to be grown throughout the year, greenhouses are increasingly important to the food supply of high-latitude countries.

Greenhouses are often used for growing flowers, vegetables, fruits, and transplants. Special greenhouse varieties of certain crops, such as tomatoes, are generally used for commercial production. Many vegetables and flowers can be grown in greenhouses in late winter and early spring, and then transplanted outside, as the weather warms.

Ventilation is one of the most important components in a successful greenhouse. If there is no proper ventilation, greenhouses and their plants can become prone to problems. The main purposes of ventilation are to regulate the temperature to the optimal level, and to ensure movement of air, and thus prevent build-up of plant pathogens (such as Botrytis cinerea) that prefer still air conditions and high humidity. Ventilation also ensures a supply of fresh air for photosynthesis and plant respiration, and may enable important pollinators to access the greenhouse crop.

In order to control ventilation of a greenhouse, holes are cut in the plastic sheets of the roof and walls of a greenhouse. It is sometimes preferable to cut holes in the plastic sheets after planting the crop, as seasons change or because the grown crop needs a different climate. In such cases, it is especially difficult to execute the cutting operation because of the uncomfortable conditions which happen to exist as the crop is grown. Wet soil, branches and leaves, watering lines, pits and clods on the ground, are all obstructions which makes it very difficult to reach closer to the walls of a greenhouse. A special problem appears when cuts are needed to be done in the plastic sheets of the roof of a greenhouse. In this case, a worker must climb on a ladder and while holding a knife in his hand, try to cut rounded holes in the plastic. Obviously, this operation needs a considerable amount of effort, and can even be very dangerous to the worker as he stands on top of the ladder when the ground is be muddy, wet or inclined.

Ideally, cutting the holes in the plastic is done in circles with a diameter of about 10 cm to 50 cm each. The thickness of the plastic sheet is regularly between 0.1 mm to 0.2 mm. Therefore, the operation of cutting such holes with a utility knife is not an easy task, when many such holes are needed at different heights and places. Moreover, the task is especially difficult, taking into account that a ladder is needed to reach greater heights of the roof, and the worker needs to descend from the ladder, move it to a new place, and climb on again, to make another hole somewhere else.

This task of cutting holes in the plastic sheets of a greenhouse which are regularly done in long straight lines with each new hole every 2 m to 4 m, will usually take a long time, and when such an operation is needed in a big greenhouse, it will be very costly labor.

All the methods described above have not yet provided satisfactory solutions to the problem of cutting holes in the plastic sheets of a greenhouse.

It is an object of the present invention to provide a cutting device for cutting the plastic of the roof and walls of a greenhouse.

It is another object of the present invention to provide a cutting device for cutting plastic in a greenhouse while reaching high places, without the need of using a ladder.

It is a further object of the present invention to provide a cutting device for cutting rounded holes with varying pre-decided diameters.

It is an object of the present invention to provide a solution to the above-mentioned and other problems of the prior art.

Other objects and advantages of the invention will become apparent as the description proceeds.

### SUMMARY OF THE INVENTION

In one aspect, the present invention is directed to a cutting device, comprising:
a disc (16), for supporting a sheet (44) while being cut;
a rod (26), perpendicularly connected to a center of the disc (16), the rod (26) having a sharpened tip (12) at an end thereof for being anchored to the sheet (44);
a cutting tool (20) connected to the rod (26), the cutting tool employing a cutting terminal (18) disposed distantly from the rod (26); and
a mechanism for rotating the cutting terminal circularly around the rod (26);
a length of the rod (26) allowing holding the cutting device from a distance to the sheet;

thereby cutting a circular cut in the sheet distantly from a user thereof.

The cutting tool (20) may be a utility knife.

The cutting terminal (18) of the cutting tool (20) may be a blade.

The cutting terminal (18) of the cutting tool (20) may be a heating filament.

The cutting device may comprise two cutting tools (20) placed on the diameter at an equal distance from the axis of rotation.

The distance of the cutting tool (20) from the axis of rotation can be decided and fixed.

The cutting device further comprises a butterfly screw (22) for tightening the cutting tool (20) to a fixed place on a pole (34).

The extension rod (36) may be able to fold off or be mounted on to be set for varying lengths, thereby allowing a user (48) to reach sheets (44) of different heights.

The extension rod (36) folds in and out in a telescopic way.

The cutting device further comprising a movement handle (30), wherein upon manually turning the movement handle (30), a user (48) rotates the cutting tool (20) in a circular motion.

The cutting device further comprises a motor for rotating the cutting tool (20) in a circular motion.

The motor may be selected from a group comprising: electric motor, hydraulic motor, and pneumatic motor.

The reference numbers have been used to point out elements in the embodiments described and illustrated herein, in order to facilitate the understanding of the invention. They are meant to be merely illustrative, and not limiting. Also, the foregoing embodiments of the invention have been described and illustrated in conjunction with systems and methods thereof, which are meant to be merely illustrative, and not limiting.

### BRIEF DESCRIPTION OF DRAWINGS

Preferred embodiments, features, aspects and advantages of the present invention are described herein in conjunction with the following drawings:

FIGS. 1 and 2 are schematic illustrations of a cutting device for cutting plastic sheet, according to one embodiment of the present invention.

FIG. 3 is a schematic illustration of a cutting device for cutting plastic sheet, according to another embodiment of the present invention.

FIG. 4 is an illustration of a user operating a cutting device for cutting plastic sheet, according to one embodiment of the present invention.

It should be understood that the drawings are not necessarily drawn to scale.

### DESCRIPTION OF EMBODIMENTS

The present invention will be understood from the following detailed description of preferred embodiments (“best mode”), which are meant to be descriptive and not limiting. For the sake of brevity, some well-known features, methods, systems, procedures, components, circuits, and so on, are not described in detail.

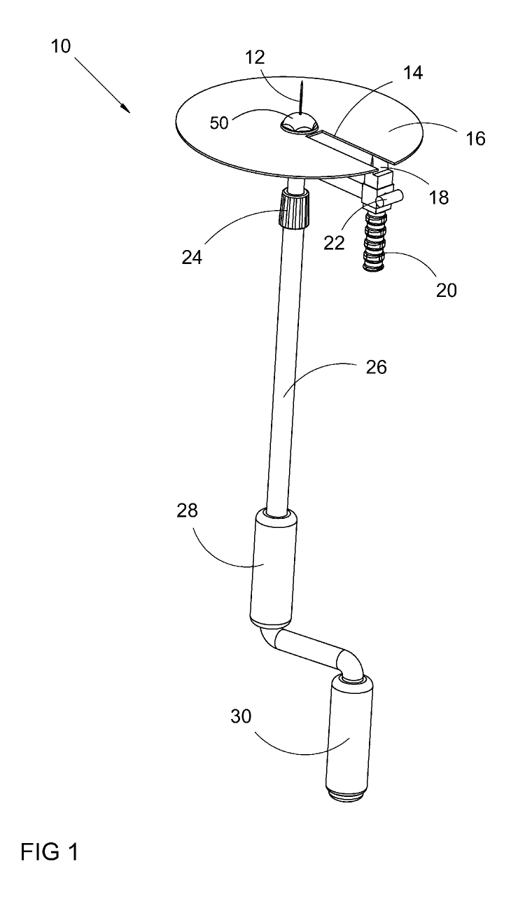

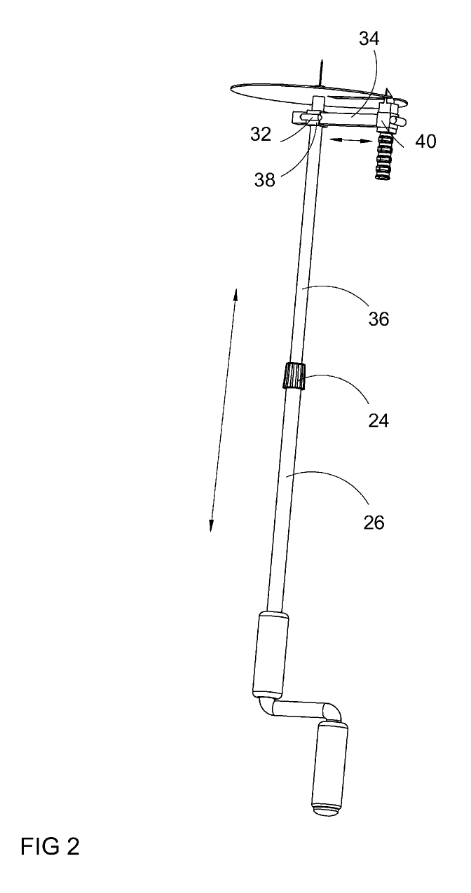

FIGS. 1 and 2 are schematic illustrations of a cutting device for cutting plastic sheet, according to one embodiment of the present invention.

According to one embodiment of the present invention, the cutting device 10 comprises a cutting tool 20 for cutting plastic sheet. The cutting tool 20 is connected to rod 36 with the help of pole 34. The cutting tool 20 revolves around the axis of sharpened tip 12, as the rotation of rod 36 set the pole 34 in a circular motion.

According to one embodiment of the present invention, rods 26 and 36 are tight together by locking thread 24. Loosening locking thread 24 enables the folding or the mounting of the cutting device 10. Before using the cutting device 10 for the operation of cutting the plastic of a greenhouse, the user must tighten the locking thread 24, thereby assembling rods 26 and 36 in a fixed position. The user can decide to set the position of the emerging extension rod 36 at different levels, depending on the height or distance of the plastic sheet he needs to cut, from where he himself is standing. If the plastic sheet is placed high above him, then he will take out the emerging extension rod 36 to its full length. In this way, the cutting device for cutting plastic sheets 10 can be used to cut holes in plastic sheets that are placed at different heights, and the user can set the total length of rods 36 and 26 to different levels.

According to one embodiment of the present invention, the mechanism for setting the lengths of rods 36 and 26 at different levels by extracting one rod from the other is enabled by a telescopic mechanism. In this way, the extraction of one rod from the other is enabled due to their difference in diameters, as one rod is enclosed within the other. In this case, the tightening screw 24 is used for setting the preferred position, by turning the tightening screw 24 clockwise, thereby tightly locking the two rods together. A similar mechanism can be constructed using more than two rods, for the purpose of reaching greater heights. In this way, three rods can be placed in such a telescopic mechanism, and therefore there are two tightening screws 24 for locking the three rods fixed together, in this example. According to another embodiment of the invention, the opening mechanism for setting the total length of the rods is made possible by using a thread in which one rod is screwed inside another, thereby by unscrewing one rod from the other, it is possible to elongate the obtained total size of rods 36 and 26.

According to another embodiment of the present invention, the cutting device for cutting plastic sheet 10 has only one rod 26 with a fixed length. In this embodiment of the invention, the cutting device 10 can be readily used, when there is no need to change the length of rod 26. In this case, a single rod 26 will be from supporting handle 28 at the bottom, to sharpened tip 12 at the other end. This embodiment of the present invention may be preferable when a cutting device for cutting plastic 10 is used in very long greenhouses where the height of the plastic sheets of the roof is constant. A cutting device for cutting plastic 10 with a single rod 26 of a fixed length will allow an elementary use for cutting holes in plastic sheets of a constant height.

According to one embodiment of the present invention, a movement handle 30 is used for turning rod 26 in a circular motion, while giving a support with the other hand of the user by grabbing the supporting handle 28. Movement handle 30 and supporting handle 28 preferably have rounded shapes, allowing a user to comfortably grasp the handles with his hands while he turns them in a manual manner. For a comfortable use of the cutting device for cutting plastic sheets 10 in a mode characteristic of a manual operating device, the rounded handles 28 and 30 are rotatable around their axes, thereby allowing the user to grasp both movement handle 30 and supporting handle 28 firmly with each of his hands, as he manually operates the cutting device. When each of the user's hands grasps the respective handle, the user turns movement handle 30 in a rounded motion that is circulating around the focal point formed by the support given from his other arm grasping supporting handle 28, and in this way, he creates the spinning movement of rods 26 and 36 (which are both fixed together) around their axes.

The revolutions of rods 26 and 36 around their axes is spinning the pole 34 in a circular motion, thereby rotating cutting tool 20 around the axis of rod 36. To cut the plastic of a greenhouse, the user in this stage imbeds the sharpened tip 12 inside the plastic sheet of the greenhouse, thereby giving another support point to the cutting device 10, and he pushes the cutting device to the plastic sheet while turning the movement handle 30 anticlockwise as the cutting tool 20 cuts a round hole in the plastic. The sharpened tip 12 is used in a way resembling the use of a drafting compass, as the sharpened tip 12 is anchored to the plastic sheet, and the pole 34 turns the cutting tool 20 in a precise circle around the point of sharpened tip 12. In this way, the cutting device for cutting plastic 10 can cut precise circles in the plastic of a greenhouse, as the user turns movement handle 30 in a circular manner while holding the cutting device 10 with cutting tool 20 against the plastic of the greenhouse.

A choice of the size of the diameter of the hole made in the plastic can be made by deciding the distance of cutting tool 20 from the point of the sharpened tip 12. If a hole with a bigger diameter is preferred, the cutting tool 20 can be taken further away from the extension rod 36, by sliding the frame 40 on the pole 34, and tightening butterfly screw 22 to set cutting tool 20 at a fixed distance from the sharpened tip 12.

Thereby it is easy, according to this embodiment of the present invention, to set the cutting tool 20 at a desired distance from the center of the circle, for making cuts with a fixed precise diameter in the plastic of the greenhouse.

According to another embodiment of the invention, the cutting device 10 may have a cutting tool 20 at a fixed distance from sharpened tip 12. A cutting device 10, according to this embodiment of the present invention, is to cut holes with a fixed size (holes having a fixed diameter).

According to another embodiment of the present invention, disc 16 is mounted between rod 36 and sharpened tip 12. The function of disc 16 is give a better support as cutting tool 20 cuts the plastic of the greenhouse. While the user spins the movement handle 30, the rotation movement revolves disc 16 around its axis at the base of sharpened tip 12. The outer surface of disc 16 offers a mechanical support for stabilizing cutting tool 20 while it cuts through the plastic of a greenhouse. Such a mechanical support facilitates the stabilization of the cutting device 10 while the sharpened tip 12 is anchored to the plastic to fix a focal point for the rotation of cutting tool 20.

At the first step, the user tacks tip 12 into sheet 44. At the second step, the user further presses disc 16 onto sheet 44. Disc 16 stretches sheet 44 around the location of tip 12, being an unmovable anchor. A protrusion 50 disposed at the center of disk 16, from which tip 12 extends, further lifts sheet 44, for increasing the stretching thereof beyond the natural area of the sheet. At the third step, the user rotates cutting tool 20. The cutting is successful around disc 16 due to the stretching of sheet 44 there, by disk 16 and further by protrusion 50. The lifting of sheet 44 by protrusion 50 cancels friction between disk 16 and sheet 44, induced by the rotation of disk 16.

Disc 16 may have a slot 14, for enabling the placement of cutting tool 20 in different positions. According to this embodiment of the present invention, cutting tool 20 can be installed on any point of pole 34, by the hold of frame 40. Butterfly screw 22 presses cutting tool 20 onto pole 34 to affix cutting tool 20 on any preferred point on pole 34, thereby deciding the desired diameter of the hole in the plastic. The slot 14 allows the user to shift the cutting tool 20 to any point desired on pole 34, by moving it through disc 16, to choose the wanted diameter of the hole.

According to another embodiment of the present invention, the use of disc 16 enables fixing cutting tool 20 directly on that disc. According to this embodiment of the present invention, the disc 16 offers the mechanical support needed to facilitate the cutting of the plastic sheet of a greenhouse, while the cutting tool 20 that is connected directly to that disc is making the cut through the plastic of the greenhouse. In this embodiment of the invention, the cutting device 10 enables the cutting of holes with a predetermined fixed diameter, where such size of holes is needed in the operation of cutting holes in a greenhouse.

According to one embodiment of the present invention, the cutting terminal 18 of cutting tool 20 can be a blade. Such cutting tool 20 can be made with a cutting terminal 18 of a blade suitable for cutting plastic. According to one embodiment of the present invention, cutting tool 20 can be a utility knife. According to one embodiment of the present invention, cutting tool 20 can be a retractable blade knife, a knife with a replaceable utility blade, a standard straight edge blade, a “snap-off blade”, a disposable razor blade, or a pocket knife.

According to another embodiment of the present invention, the cutting terminal 18 of the cutting tool 20 can be a hot filament. In this embodiment of the invention, the cutting tool 20 comprises a heated filament suitable to cut the plastic of a greenhouse. Such a filament can be heated with electric power to a high temperature, enabling instant scorching of the plastic sheets. A relatively thin filament may be preferred for enabling a precise cut in the plastic sheets of the greenhouse, and even if the cutting terminal 18 of cutting tool 20 should spin very fast, the plastic will immediately burn and the cutting device 10 will make a circular hole in the plastic of the greenhouse.

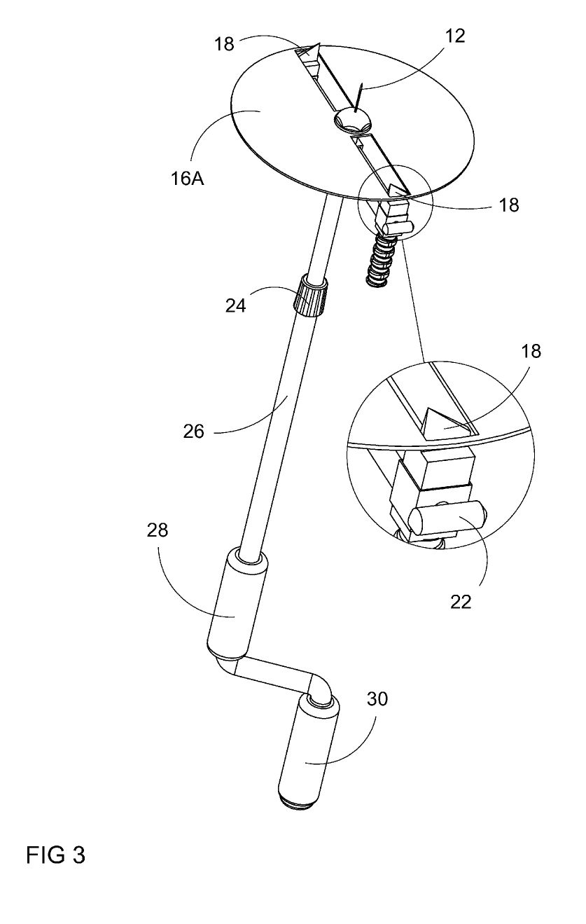

FIG. 3 is a schematic illustration of a cutting device for cutting plastic sheet, according to another embodiment of the present invention.

According to another embodiment of the present invention, a cutting device for cutting plastic sheet is having two cutting tools 20. The use of two cutting tools for cutting plastic in a greenhouse is preferable according to another embodiment of the present invention, as the cutting of the plastic is made easier and it offers a smooth operation of the cutting device because the simultaneous press of the two cutting tools 20 from both sides balances each other.

According to this embodiment of the present invention, while the user rotates movement handle 30, the rotation of extension rod 36 revolves both cutting tools 20 attached to pole 34.

According to another embodiment of the present invention, disc 16A is mounted between extension rod 36 and the sharpened tip 12. The purpose of disc 16A is to offer a surface of support for the cutting device 10 when cutting the plastic. It also serves for collecting the circles of plastic that have been cut. The plastic that has been cut with the cutting device is accumulated on the surface of disc 16A, and the user can remove the pieces from sharpened tip 12.

According to another embodiment of the present invention, both cutting tools 20 can be adjusted for deciding the diameter size of the holes to be made in the plastic of the greenhouse. For deciding a size of the hole to be made in the plastic, the user first sets both cutting tools 20 to identical distance from sharpened tip 12, and then the user affixes the cutting tools to the pole by tightening butterfly screws 22. Disc 16A is shown in FIG. 3 to have two slots 14, from both sides. The slots 14 enable the movement of cutting tools 20 before affixing them in an identical distance from the center of disc 16A.

According to another embodiment of the present invention, the cutting terminals 18 of cutting tools 20 are two blades. The blades of cutting tools 20 can be replaceable, and once a blade becomes blunt, it is easy to replace. The replacement of cutting terminal 18 can also be done by breaking off the dull section of a “snap-off blade”. In the bubble in FIG. 3, cutting terminal 18 is seen prominent from the slot, and from the other side of disc 16A, we see butterfly screw 22, with which cutting tool 20 is fixed.

According to another embodiment of the present invention, cutting terminals 18 can be directly connected to disc 16A.

According to another embodiment of the present invention, the cutting tools 20 can be fixed in a permanent position with a certain distance from sharpened tip 12. This is suitable in cases where holes with a predetermined size are wanted made in the plastic of the greenhouse.

According to another embodiment of the present invention, cutting terminals 18 of cutting tools 20 can be heating filaments.

According to another embodiment of the present invention, the cutting device 10 can be operated by an electric motor.

According to another embodiment of the present invention, the rotational motion of cutting tools 20 can be supplied by a pneumatic, hydraulic, or another mechanical power.

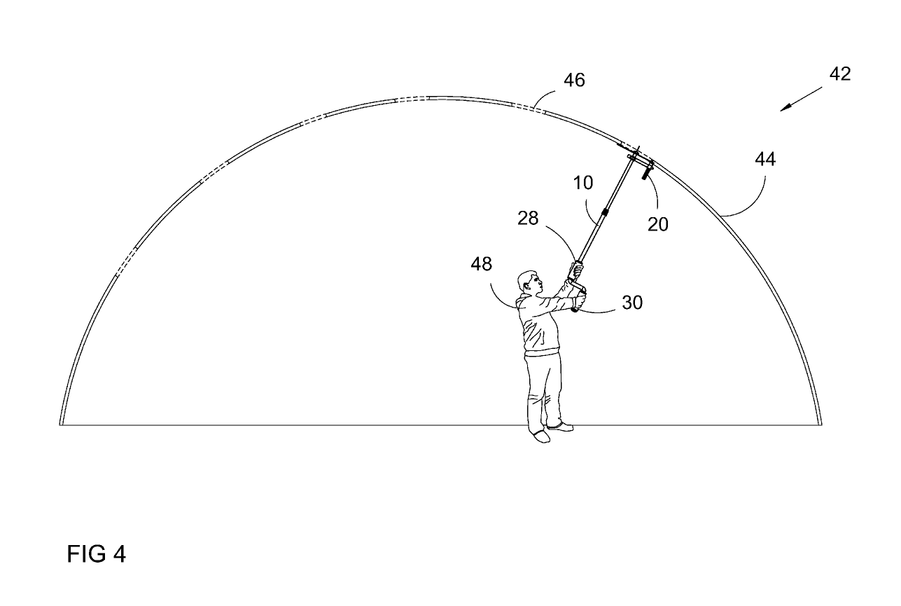

FIG. 4 is an illustration of a user operating a cutting device for cutting plastic sheet, according to one embodiment of the present invention.

In FIG. 4, we see a user operating a cutting device for cutting the plastic sheets of a greenhouse 42, according to one embodiment of the present invention. The user 48 is seen to hold supporting handle 28 with his left arm, and movement handle 30 with his right arm. In this position, he spins with his right arm movement handle 30 in a circular motion around his hold of supporting handle 28. The disc 16 on the other side of the cutting device 10 gives a moment of support against the plastic sheet of the greenhouse 44.

The operation of movement handle 30 transmits a rotation motion (through the rod) to the cutting tool 20. The cutting tool spins in a circle around the axis formed by the rod, and cuts a circular hole 46 in the plastic sheet of greenhouse 44. In FIG. 4 we can see some holes 46 that have been made in the plastic sheet of greenhouse 44 by user 48.

According to another embodiment of the present invention, the rotation of the cutting device for cutting plastic sheet 10 can be supplied by an electric motor, a hydraulic motor, or a pneumatic motor.

In the figures and/or description herein, the following reference numerals (Reference Signs List) have been mentioned:
numeral 10 denotes a cutting device for cutting a plastic sheet;
numeral 12 denotes a sharpened tip;
numeral 14 denotes a slot;
numerals 16 and 16A denote discs;
numeral 18 denotes a cutting terminal;
numeral 20 denotes a cutting tool;
numeral 22 denotes a butterfly screw;
numeral 24 denotes a tightening screw;
numeral 26 denotes a rod;
numeral 28 denotes a supporting handle;
numeral 30 denotes a movement handle;
numeral 32 denotes a butterfly screw;
numeral 34 denotes a pole;
numeral 36 denotes an extension rod;
numeral 38 denotes a frame;
numeral 40 denotes another frame;
numeral 42 denotes a user operating a cutting device for cutting the plastic sheets of a greenhouse;
numeral 44 denotes a plastic sheet in a greenhouse;
numeral 46 denotes a hole in the plastic sheet of a greenhouse;
numeral 48 denotes a user; and
numeral 50 denotes a protrusion disposed at the center of disk 16, from which tip 12 extends.

The foregoing description and illustrations of the embodiments of the invention has been presented for the purposes of illustration. It is not intended to be exhaustive or to limit the invention to the above description in any form.

Any term that has been defined above and used in the claims, should to be interpreted according to this definition.

The reference numbers in the claims are not a part of the claims, but rather used for facilitating the reading thereof. These reference numbers should not be interpreted as limiting the claims in any form.

1. A cutting device, comprising:
a disc (16), for attaching a sheet (44), for stretching thereof while being cut;
a rod (26), perpendicularly connected to a center of said disc (16), said rod (26) having a sharpened tip (12) at an end thereof for being anchored to said sheet (44), and for determining a center of the stretched area of said sheet (44);
a cutting tool (20) connected to said rod (26), said cutting tool employing a cutting terminal (18) disposed distantly from said rod (26); and
a mechanism for rotating said cutting terminal circularly around said rod (26);
wherein a length of said rod (26) allows holding said cutting device from a distance to said sheet;
thereby stretching said sheet (44) for cutting a circular cut in said sheet (44) distantly from a user thereof.

2. A cutting device according to claim 1, wherein said cutting tool (20) is a utility knife.

3. A cutting device according to claim 1, wherein said cutting terminal (18) of said cutting tool (20) is a blade.

4. A cutting device according to claim 1, wherein said cutting terminal (18) of said cutting tool (20) is a heating filament.

5. A cutting device according to claim 1, wherein said cutting device comprises two cutting tools (20) placed on the diameter at an equal distance from the axis of rotation.

6. A cutting device according to claim 5, wherein the distance of said cutting tools (20) from the axis of rotation can be decided and fixed.

7. A cutting device according to claim 6, comprising butterfly screws (22) for tightening said cutting tools (20) to a fixed place on a pole (34).

8. A cutting device according to claim 5, wherein an extension rod (36) is able to fold off or be mounted on to be set for varying lengths, thereby allowing a user (48) to reach sheets (44) of different heights.

9. A cutting device according to claim 8, wherein said extension rod (36) folds in and out in a telescopic way.

10. A cutting device according to claim 5, wherein said cutting mechanism comprises a motor for rotating said cutting tools (20) in said circular motion.

11. A cutting device according to claim 10, wherein said motor is selected from a group comprising: electric motor, hydraulic motor, and pneumatic motor.

12. A cutting device according to claim 1, wherein said cutting mechanism comprises a movement handle (30), wherein upon manually turning said movement handle (30), a user (48) rotates said cutting tools (20) in a circular motion.

13. A cutting device according to claim 1, wherein the distance of said cutting tool (20) from the axis of rotation can be decided and fixed.

14. A cutting device according to claim 13, comprising a butterfly screw (22) for tightening said cutting tool (20) to a fixed place on a pole (34).

15. A cutting device according to claim 1, wherein an extension rod (36) is able to fold off or be mounted on to be set for varying lengths, thereby allowing a user (48) to reach sheets (44) of different heights.

16. A cutting device according to claim 15, wherein said extension rod (36) folds in and out in a telescopic way.

17. A cutting device according to claim 1, comprising a movement handle (30), wherein upon manually turning said movement handle (30), a user (48) rotates said cutting tool (20) in a circular motion.

18. A cutting device according to claim 1, comprising a motor for rotating said cutting tool (20) in a circular motion.

19. A cutting device according to claim 18, wherein said motor is selected from a group comprising: electric motor, hydraulic motor, and pneumatic motor.

20. A cutting device according to claim 1, further comprising:
a protrusion (50) disposed between said disc (16) and said tip (12), for canceling friction between said disk (16) and said sheet (44).

21. A use of a cutting device in the cutting of a sheet of a greenhouse wall, wherein said device comprises:
a disc (16), for supporting and stretching said sheet (44) while being cut;
a rod (26), perpendicularly connected to a center of said disc (16), said rod (26) having a sharpened tip (12) at an end thereof for being anchored to said sheet (44), and for determining a center of the stretched area of said sheet (44);
a cutting tool (20) connected to said rod (26), said cutting tool employing a cutting terminal (18) disposed distantly from said rod (26); and
a mechanism for rotating said cutting terminal circularly around said rod (26);
wherein a length of said rod (26) allows holding said cutting device from a distance to said sheet.
